(19) United States
(12) Patent Application Publication
(10) Pub. No.: US 2024/0196228 A1
(43) Pub. Date: Jun. 13, 2024

(54) CONTROL SYSTEM, CONTROL APPARATUS, CONTROL METHOD AND PROGRAM

(71) Applicant: NIPPON TELEGRAPH AND TELEPHONE CORPORATION, Tokyo (JP)

(72) Inventors: Daisuke MURAYAMA, Tokyo (JP); Shota NAKAYAMA, Tokyo (JP)

(21) Appl. No.: 18/263,579

(22) PCT Filed: Feb. 2, 2021
(86) PCT No.: PCT/JP2021/003660

§ 371 Date: Jul. 31, 2023

(51) Int. Cl. H04W 16/28; H04W 16/18

(52) U.S. Cl. CPC H04W 16/28; H04W 16/18

(57) ABSTRACT

A control system includes a plurality of base stations capable of changing a transmission point of radio waves in a space, and a control device that includes a memory and a processor configured to generate a shield map indicating a position and a shape of a shield against the radio waves in the space; calculate, for each combination of values of one or more parameters for determining the transmission point, an index value related to a range in which radio waves of one or more of the base stations are not shielded by the shield based on the transmission point of each of the plurality of base stations in the combination and the shield map; and control change of the transmission point of each of the plurality of base stations based on the combination in which the index value has a maximum value.

### TECHNICAL FIELD

The present invention relates to a control system, a control device, a control method, and a program.

### BACKGROUND ART

In the 5th generation mobile communication system (5G (Above-6 GHz)) , a high frequency band called a millimeter wave band has been used in addition to the existing frequency bands. Because radio waves of a high frequency band called Above-6 such as the 28 GHz band that is available in 5G or local 5G generally have large distance attenuation, for example, long-distance transmission is realized by using a beam forming transmission technique with a ultra-high gain according to NPL 1.

### CITATION LIST

### Non Patent Literature

[NPL 1] Yoshihisa Kishiyama, et al., “5G Outdoor Experiment For Ultra-High Speed And Long Distance Transmission Using Millimeter Waves”, NTT DOCOMO Technical Journal Vol. 26, No. 1, Apr. 2018

### SUMMARY OF INVENTION

### Technical Problem

Here, a situation in which a communication area is formed by using a plurality of 5G base stations in a space where a quasi-static or dynamic large shield is likely to move, such as a factory or a warehouse, is assumed.

In this case, radio waves of a high frequency band have high straightness and large loss due to such a shield, and thus a communication area is required to be formed in accordance with the shield.

The present invention has been made in view of the above-described points and aims to form a communication area according to a shield.

### Solution to Problem

Thus, in order to solve the above-described problem, a control system includes a plurality of base stations capable of changing a transmission point of radio waves in a space and a control device, in which the control device includes a generation unit that generates a shield map indicating a position and a shape of a shield against the radio waves in the space, a calculation unit that calculates, for each combination of values of one or more parameters for determining the transmission point, an index value related to a range in which radio waves of one or more of the base stations are not shielded by the shield based on the transmission point of each of the plurality of base stations in the combination and the shield map, and a control unit that controls change of the transmission point of each of the plurality of base stations based on the combination in which the index value has a maximum value.

### Advantageous Effects of Invention

A communication area can be formed according to a shield.

### BRIEF DESCRIPTION OF DRAWINGS

FIG. 1 is a diagram illustrating a configuration example of a control system according to a first embodiment.

FIG. 2 is a diagram for describing a mobile base station 20 in detail.

FIG. 3 is a diagram illustrating a hardware configuration example of a control device 10 according to the first embodiment.

FIG. 4 is a diagram illustrating a functional configuration example of the control device 10 according to the first embodiment.

FIG. 5 is a flowchart for describing an example of a processing procedure performed by the control device 10 according to the first embodiment.

FIG. 6 is a diagram for describing a visibility range.

FIG. 7 is a diagram showing an example of calculation results of index values according to the first embodiment.

FIG. 8 is a flowchart for describing an example of a processing procedure of a specific process of a combination of values of position/direction parameters in which an index value has a maximum value.

FIG. 9 is a flowchart for describing an example of a processing procedure performed by a control device 10 according to a second embodiment.

FIG. 10 is a flowchart for describing an example of a processing procedure performed by a control device 10 according to a third embodiment.

### DESCRIPTION OF EMBODIMENTS

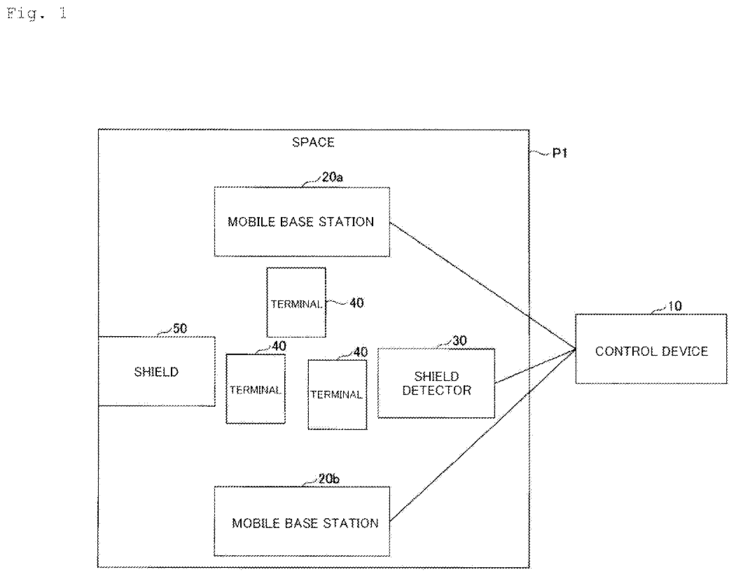

Embodiments of the present invention will be described below based on the accompanying drawings. FIG. 1 is a diagram illustrating a configuration example of a control system according to a first embodiment. The control system includes a plurality of mobile base stations 20 (mobile base stations 20a and 20b), a shield detector 30, a control device 10, and the like as illustrated in FIG. 1. Further, the mobile base stations 20 and the control device 10 are communicatively connected using wires or wirelessly. Similarly, the shield detector 30 and the control device 10 are communicatively connected using wires or wirelessly.

The mobile base stations 20 are mobile-type base stations 21 that form a communication area in a space P1 such as a factory or a warehouse. The mobile type means that a transmission point of radio waves can be changed. The mobile base stations 20, for example, transmit and receive radio waves of a high frequency band used in the 5th generation mobile communication system (5G) to achieve high-speed and large-capacity wireless communication with terminals 40. Such a terminal 40 includes a communication device, for example, a smartphone, a tablet terminal, a personal computer (PC), or the like. Although FIG. 1 illustrates an example in which the two mobile base stations 20 including the mobile base station 20a and the mobile base station 20b are disposed in the space P1, three or more mobile base stations 20 may be disposed in the space P1.

The shield detector 30 has an imaging device for detecting a shield 50 in the space P1 or a Laser Imaging Detection and Ranging (LIDAR) device. The shield detector 30 transmits sensing information such as video information photographed by the imaging device or LIDAR information measured by the LIDAR device (which will be referred to as “shield detection information” below) to the control device 10. The shield 50 refers to an object capable of shielding radio waves coming from the mobile base stations 20. The shield 50 is not necessarily fixed, and may move quasi-statically or dynamically. Further, the shield 50 may be detected by each terminal 40. In this case, each terminal 40 detects a shield 50 around itself, and transmits shield detection information about the shield 50 that it has detected to the control device 10. Further, although an example in which there is only one shield 50 is shown in FIG. 1, there may be a plurality of shields 50 in the space P1.

The control device 10 is one or more computers that execute processing for forming a communication area corresponding to the shield 50 by controlling change of a transmission point of radio waves of the mobile base stations 20 based on the shield detection information. In the present embodiment, change of a transmission point is realized by changing a position and a direction of the mobile base stations 20. A direction of a mobile base station 20 is a transmission direction of radio waves. Specifically, the control device 10 specifies a position and a direction of each mobile base station 20 in which an index value of a communication area in the space P1 is optimized based on the shield detection information, and controls the position and the direction of each mobile base station 20 by transmitting a parameter indicating the position and the direction (which will be referred to as a “position/direction parameter”) to each of the mobile base stations 20. Further, a position/direction parameter is an example of one or more parameters for determining a transmission point of radio waves.

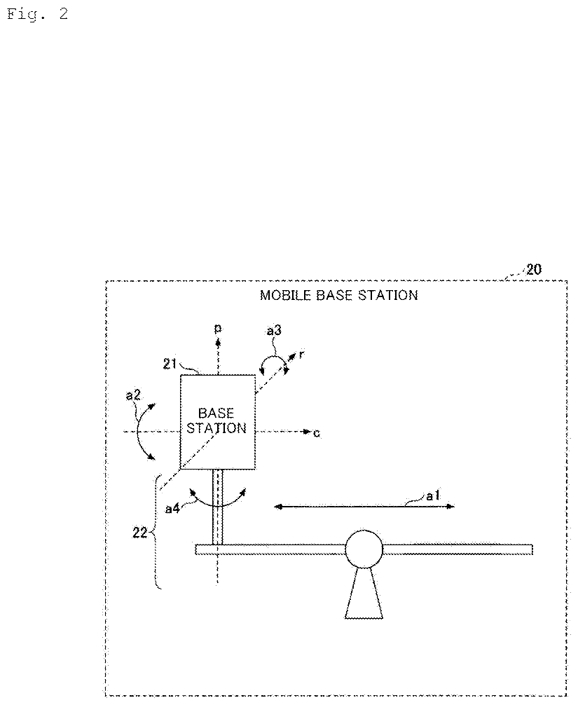

FIG. 2 is a diagram for describing a mobile base station 20 in detail. The mobile base station 20 has a base station 21 that transmits radio waves and a mobile structure 22 that supports the base station 21 to be movable as illustrated in FIG. 2. Further, in particular, when referring to the base station 21 and the mobile structure 22 of the mobile base station 20a, “a” will be added to the end of each reference numeral. Likewise, when referring to the base station 21 and the mobile structure 22 of the mobile base station 20b, “b” will be added to the end of each reference numeral.

The mobile structure 22 includes, for example, a rail capable of changing a position of the base station 21 to cause the base station 21 to move (slide) in an arrow a1 direction on the rail based on a position/direction parameter transmitted from the control device 10. As a result, the position of the base station 21 (a transmission point of radio waves) is changed.

In addition, the mobile structure 22 may cause, for example, the base station 21 to revolve around a c axis (see reference sign a2) , around an r axis (see reference sign a3), and around a p axis (see reference sign a4) based on the position/direction parameter transmitted from the control device 10. As a result, the direction of the base station 21 (transmission direction of radio waves) changes.

Further, a rotation angle around the c axis is referred to as a tilt angle, a rotation angle around the r axis is referred to as a roll angle, and a rotation angle around the p axis is referred to as a panning angle. That is, a tilt angle, a roll angle and a panning angle are parameters representing a direction of the base station 21.

Although FIG. 2 illustrates an example in which the base station 21 moves on a fixed rail, the configuration for changing a position and a direction of the base station 21 is not limited to this. For example, the mobile base station 20 may be constructed by mounting the base station 21 on a drone or an automatic guided vehicle (AGV). In such a case, the control device 10 can control the position and direction of the base station 21 by controlling the drone or the AGV. Furthermore, the position and direction may be manually changed.

In addition, it has been described above that a transmission point and a transmission direction of radio waves of the base station 21 can be changed by physically moving a position and a direction of the base station 21. However, when the mobile base station 20 is constructed by using, for example, a distributed antenna system, the transmission point and the transmission direction of radio waves of the base station 21 may be controlled by controlling output of each unit. In this case, the mobile base station 20 controls the output of each unit of the distributed antenna system based on an Enable/Disable signal transmitted from the control device 10, thereby controlling the transmission point and the transmission direction of the radio waves of the base station 21. In other words, the parameters for determining the transmission point and transmission direction of the radio waves of the base station 21 may include an Enable/Disable signal, for example, in addition to the position/direction parameter. However, a case in which a transmission point and a transmission direction of radio waves of the base station 21 are controlled by physically moving a position and a direction of the base station 21 will be described below.

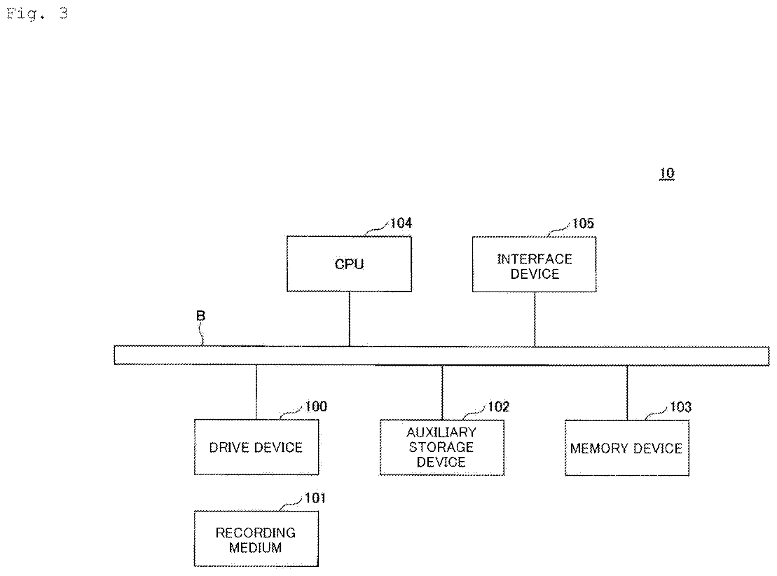

FIG. 3 is a diagram illustrating a hardware configuration example of the control device 10 according to the first embodiment. The control device 10 of FIG. 3 includes a drive device 100, an auxiliary storage device 102, a memory device 103, a CPU 104, an interface device 105, etc. connected with each other by a bus B.

A program that realizes processing in the control device 10 is provided by a recording medium 101 such as a CD-ROM. When the recording medium 101 storing the program is set in the drive device 100, the program is installed from the recording medium 101 to the auxiliary storage device 102 via the drive device 100. However, the program does not necessarily have to be installed from the recording medium 101, and may be downloaded from another computer through a network. The auxiliary storage device 102 stores the installed program and also stores necessary files, data, and the like.

When an instruction to activate the program is given, the memory device 103 reads out the program from the auxiliary storage device 102 and stores the program. The CPU 104 executes functions relevant to the control device 10 according to the program stored in the memory device 103. The interface device 105 is used as an interface for connection to a network.

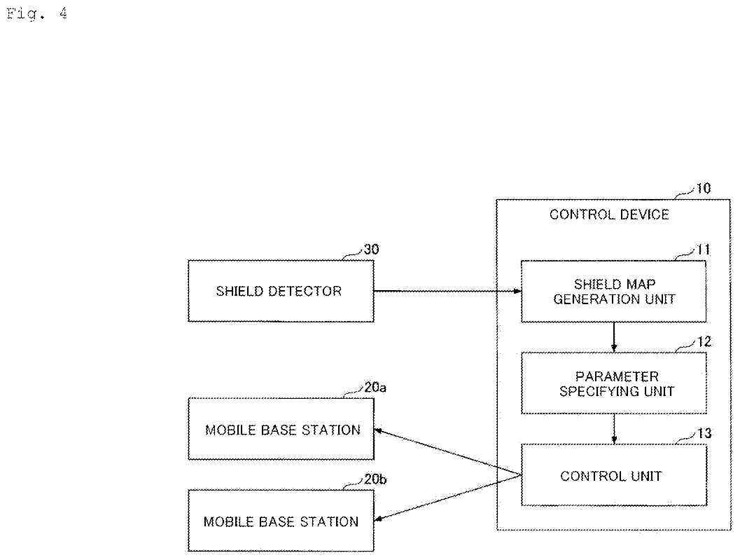

FIG. 4 is a diagram illustrating a functional configuration example of the control device 10 according to the first embodiment. Referring to FIG. 4, the control device 10 includes a shield map generation unit 11, a parameter specifying unit 12, and a control unit 13. The respective units are realized through processing of the CPU 104 to execute one or more programs installed in the control device 10. The programs may be recorded in a recording medium to be distributed, or may be distributed through the network.

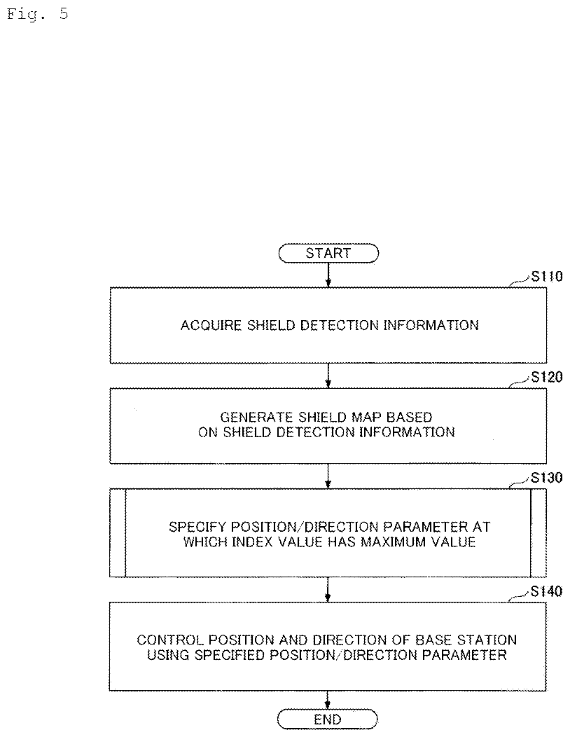

Hereinafter, a processing procedure executed by the control device 10 will be described. FIG. 5 is a flowchart for describing an example of a processing procedure performed by a control device 10 according to the first embodiment.

In step S110, the shield map generation unit 11 acquires shield detection information from the shield detector 30 or each terminal 40, or the shield detector 30 and each terminal 40.

Subsequently, the shield map generation unit 11 generates a shield map based on the acquired shield detection information (S120). The shield map refers to two-dimensional or three-dimensional map data indicating the position and shape of the shield 50. The shield map generation unit 11 generates the shield map by calculating a position and a size (a shape) of the shield 50 based on, for example, the shield detection information.

Te parameter specifying unit 12 calculates, for each combination of values that can be taken for position/direction parameters of each base station 21, an index value (which will be referred to simply as an “index value” below) of a range in a visibility relationship with any base station 21 (at the transmission point of radio waves) (which will be referred to as a “visibility range” below) based on the shield map, and specifies the combination in which the index value has a maximum value (S130). In the first embodiment, a size of the visibility range (which will be referred to as a “visibility range size” below) is calculated as an index value. The visibility range may be specified in two dimensions or specified in three dimensions. When the visibility range is specified in two dimensions, the visibility range size is the area of the visibility range. When the visibility range is specified in three dimensions, the visibility range size is the volume of the visibility range. A visibility range refers to a range in which radio waves from one or more base stations 21 (transmission points of the radio wave) is not shielded by the shield 50 in the space P1. Further, an area which does not correspond to the visibility range is referred to as a “non-visibility range”.

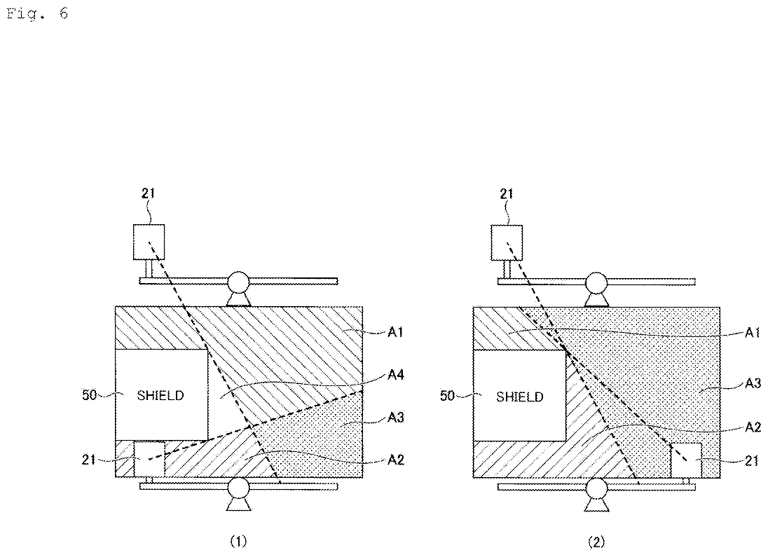

FIG. 6 is a diagram for describing visibility ranges. FIG. 6 exemplifies two two-dimensional visibility ranges including No. (1) and No. (2). In Nos. (1) and (2), the position of the base station 21 differs.

In each of Nos. (1) and (2), the area A1 is a visibility range only for the mobile base station 20a. Thus, the area A1 is a non-visibility range for the mobile base station 20b. An area A2 is a visibility range only for the mobile base station 20b. Thus, the area A2 is a non-visibility range for the mobile base station 20a. An area A3 is a visibility range for both the mobile base station 20a and the mobile base station 20b. An area A4 is a non-visibility range.

According to the above description, the area constituted by the area A1, the area A2 and the area A3 is a visibility range for one or more base stations 21.

Further, as is apparent from the comparison between Nos. (1) and (2) in FIG. 6, the visibility ranges can be changed depending on a position of the base stations 21. Specifically, no non-visibility range is present in No. (2). Similarly, the visibility ranges can be changed depending on a direction of the base stations 21. That is, the visibility ranges can be changed according to a combination of values of position/direction parameters. Thus, the shield map generation unit 11 calculates an index value (a visibility range size) for each of a plurality of combinations of values of the position/direction parameters.

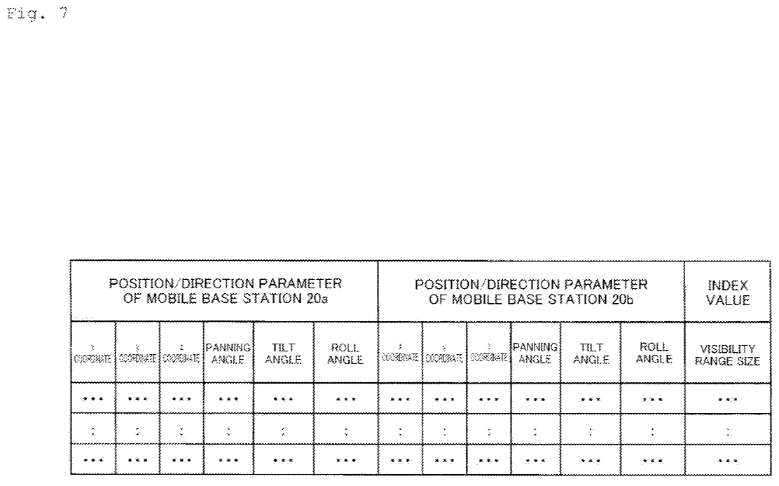

FIG. 7 is a diagram showing an example of the calculation results of index values according to the first embodiment. FIG. 7 shows that the visibility range sizes are calculated for each combination of values of the position/direction parameters related to the base station 21a and values of the position/direction parameters related to the base station 21b. Further, in the example shown in FIG. 7, a combination of values of the position/direction parameters refers to a combination of values of each of the x coordinate, the y coordinate, the z coordinate, the panning angle, the tilt angle, and the roll angle. The x coordinate is a value corresponding to a position of the base station 21 (a transmission point of radio waves) on one coordinate axis of a two-dimensional coordinate system on a horizontal plane (e.g., on the bottom) of the space P1. The y coordinate is a value corresponding to a position of the base station 21 (a transmission point of radio waves) on the other coordinate axis of the two-dimensional coordinate system. The z coordinate is a value corresponding to a position of the base station 21 (a transmission point of radio waves) on the coordinate axis in the vertical direction (i.e., the height direction) to the horizontal plane.

The parameter specifying unit 12 specifies a combination of values of the position/direction parameters in which the visibility range size has a maximum value from among the calculation results shown in FIG. 7.

Subsequently, the control unit 13 controls change of the position and direction of each base station 21 (i.e., the transmission point of the radio wave) by transmitting the combination of the values of the position/direction parameters specified by the parameter specifying unit 12 (which will be referred to as “specific parameter values” below) to each mobile base station 20 (S140). That is, the control unit 13 transmits the value of the position/direction parameter related to the mobile base station 20a among the specific parameter values to the mobile base station 20a, and transmits the value of the position/direction parameter related to the mobile base station 20b to the mobile base station 20b.

Further, the processing procedure shown in FIG. 5 may be executed at a predetermined cycle or each time the shield detection information changes, (i.e., each time the position or shape of the shield 50 changes). With this configuration, an appropriate communication area can be formed according to movement of the shield 50.

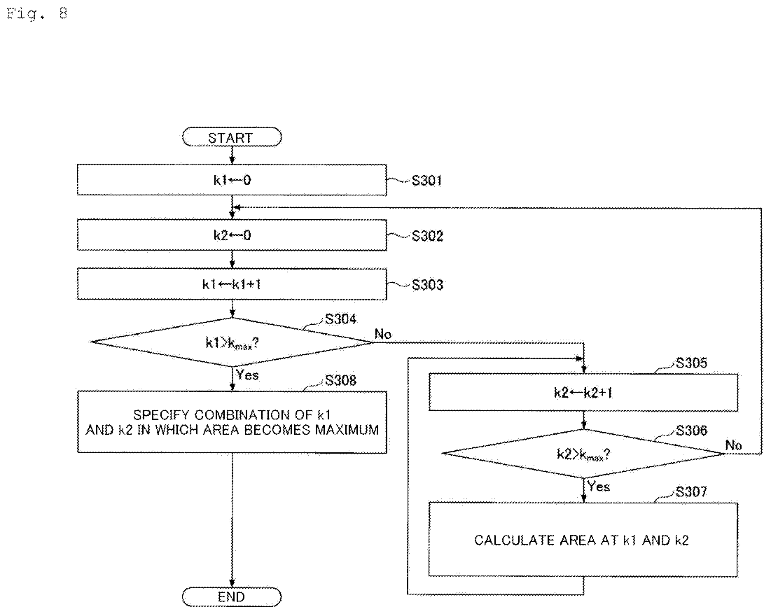

Next, step S130 will be described in detail. FIG. 8 is a flowchart for describing an example of a processing procedure of a specific process of a combination of values of position/direction parameters in which the index value has a maximum value.

In step S301, the parameter specifying unit 12 initializes a variable k1 to 0. Subsequently, the parameter specifying unit 12 initializes a variable K2 to 0 (S302). Further, the variable k1 is a variable for identifying a combination to be processed among the combinations of values of the position/direction parameters related to the mobile base station 20a. The variable k2 is a variable for identifying a combination to be processed among the combinations of values of the position/direction parameters related to the mobile base station 20b.

Then, the parameter specifying unit 12 adds 1 to the variable k1 (S303). At the timing of step S303, a new (unprocessed) combination of values of the position/direction parameters related to the mobile base station 20a may be generated. In a case in which the position/direction parameters include the items as shown in FIG. 7, the value of at least one item is changed. The change width may be arbitrarily determined.

Next, the parameter specifying unit 12 determines whether the value of the variable k1 exceeds kₘₐₓ (S304). kₘₐₓ is the number of combinations of values that can be taken for the position/direction parameters. However, combinations of values that can be taken for the position/direction parameters do not have to be all theoretical combinations. For example, a value which can be taken for each item of the position/direction parameters may be determined, and all or some of combinations of values which can be taken for each item may be combinations of values that can be taken for the position/direction parameters.

When the value of the variable k1 is equal to or smaller than kₘₐₓ (Yes in S304) , the parameter specifying unit 12 adds 1 to the variable k2 (S304). Further, at the timing of step S303, a new (unprocessed) combination of values of the position/direction parameters related to the base station 21b may be generated.

Next, the parameter specifying unit 12 determines whether the value of the variable k2 exceeds kₘₐₓ (S304). Further, although the embodiment is based on the example in which the number of combinations of values that can be taken for the position/direction parameters related to the mobile base station 20a and the number of combinations of values that can be taken for the position/direction parameters related to the mobile base station 20b are both kₘₐₓ, a value different from kₘₐₓ may be compared with k2 in the step S304 if the numbers of combinations have different values.

Subsequently, the parameter specifying unit 12 specifies a visibility range for a k1-th combination (which will be referred to as a “parameter value k1” below) among values of the position/direction parameters of the mobile base station 20a and a k2-th combination (which will be referred to as a “parameter value k2” below) among values of the position/direction parameters of the mobile base station 20b and calculates an index value of the visibility range (a visibility range size) (S307). The parameter specifying unit 12 stores the calculation result in the memory device 103, the auxiliary storage device 102, or the like in association with a set of the parameter value k1 and the parameter value k2 (S307).

Subsequently, the parameter specifying unit 12 repeats step S305 and the subsequent steps until the value of k2 exceeds kₘₐₓ. Thus, a visibility range size is calculated for each set of the current parameter value k1 and each parameter value k2.

If the value of k2 exceeds kₘₐₓ (No in S306) , the parameter specifying unit 12 repeats step S302 and the subsequent steps. Thus, a visibility range size is calculated for each set of each parameter value k1 and each parameter value k2.

When the value of k1 exceeds kₘₐₓ (No in S304) , the parameter specifying unit 12 specifies the set of the parameter value k1 and the parameter value K2 corresponding to a maximum value in the visibility range size calculated in step S307 (S308).

Further, although an example in which only the mobile base stations 20 are disposed has been introduced in the above description, one or more base stations having no mobile function (which will be referred to as “fixed base stations” below) and a plurality of mobile base stations 20 may be disposed. In this case, by performing similar processing with fixed position/direction parameters of the fixed base stations, a position and a direction of each mobile base station 20 for forming a communication area in which an index value is optimized can be specified.

As described above, according to the first embodiment, values that maximize a size of a visibility range (a communication area) that changes in accordance with a position and a shape of the shield 50 can be specified for a position and a direction of each base station 21. Therefore, a communication area can be formed according to a shield.

In addition, because the size of the visibility range is maximized according to the first embodiment, the overall quality can be improved as much as possible when there is a possibility of many terminals 40 not being detected.

Next, a second embodiment will be described. In the second embodiment, differences from the first embodiment will be described. Points which are not mentioned particularly in the second embodiment may be similar to those of the first embodiment.

In the second embodiment, an index value of a communication area differs from that in the first embodiment. Specifically, in the second embodiment, the number of terminal 40s having a visibility relationship (which will be referred to as a “visibility terminal” below) is an index value. The visibility terminal refers to a terminal 40 included in a visibility range. When the index value changes, the processing procedure executed by a control device 10 of the second embodiment changes as follows.

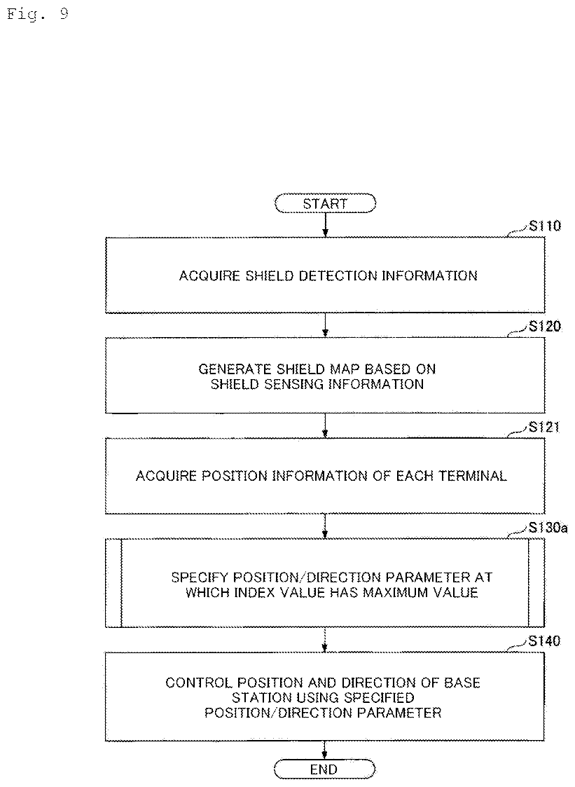

FIG. 9 is a flowchart for describing an example of a processing procedure performed by the control device 10 according to the second embodiment. Steps in FIG. 9 that are the same as in FIG. 5 are denoted by the same step Nos., and description thereof will be omitted. In FIG. 9, step S130 is changed to step S130a, and step S121 is added between step S120 and step S130a.

In step S121, the parameter specifying unit 12 acquires position information of each terminal 40. Position information of a certain terminal 40 (which will be referred to as “terminal position information” below) refers to information indicating a position of the terminal 40. Although the terminal position information may be preferably information that enables the position in the space P1 to be ascertained, it may be wide-area position information. For example, the terminal position information may be position information measured with a Global Positioning System (GPS) function of the terminal 40, or position information measured by using a sensor or the like included in the terminal 40. In this case, each terminal 40 transmits the terminal position information to the control device 10 by using an upstream data channel (or a control channel). Alternatively, the terminal position information of each terminal 40 may be estimated by a base station 21 or the control device 10 analyzing videos of a camera.

In step S130a, the parameter specifying unit 12 calculates, for each combination of values that can be taken for a position/direction parameter of each base station 21, an index value (the number of visibility terminals) based on a shield map and each piece of terminal position information, and specifies the combination in which the index value has a maximum value.

More specifically, in a step S307 of FIG. 8, a parameter specifying unit 12 specifies a visibility range for the parameter value k1 and the parameter value k2, and specifies a terminal 40 (a visibility terminal) included in the visibility range based on the visibility range and each piece of the terminal position information. The parameter specifying unit 12 counts the number of the visibility terminals, and stores the count result in the memory device 103, the auxiliary storage device 102, or the like in association with a set of the parameter value k1 and the parameter value k2. Therefore, in the second embodiment, information in which the column of “index value” in FIG. T2 is changed to “the number of visibility terminals” is calculated in step S307.

In step S308 of FIG. 8, the parameter specifying unit 12 specifies a set of the parameter value k1 and the parameter value k2 corresponding to the maximum value among the number of the visibility terminals calculated in step S307.

As described above, according to the second embodiment, values that maximize the number of visibility terminals that change in accordance with a position, a shape, and the like of the shield 50 can be specified for a position and a direction of each base station 21. Therefore, a communication area can be formed according to the shield 50.

In addition, according to the second embodiment, improvement in the communication quality of active terminals 40 can be expected.

Further, the second embodiment is suitable for a situation in which presence or position of the terminals 40 can be managed or detected, such as use of the closed areas of local 5G or the like.

Next, a third embodiment will be described. Points different from those of the first or second embodiment will be described in the third embodiment. Points which are not mentioned particularly in the third embodiment may be similar to those of the first or second embodiment.

In the third embodiment, an index value of a communication area is different from those of each of the above-described embodiments. Specifically, in the third embodiment, the sum of communication amounts of visibility terminals is used as an index value. Further, a communication amount of a terminal 40 may be an amount of traffic or a throughput. A processing procedure executed by a control device 10 of the third embodiment changes as follows by changing an index value.

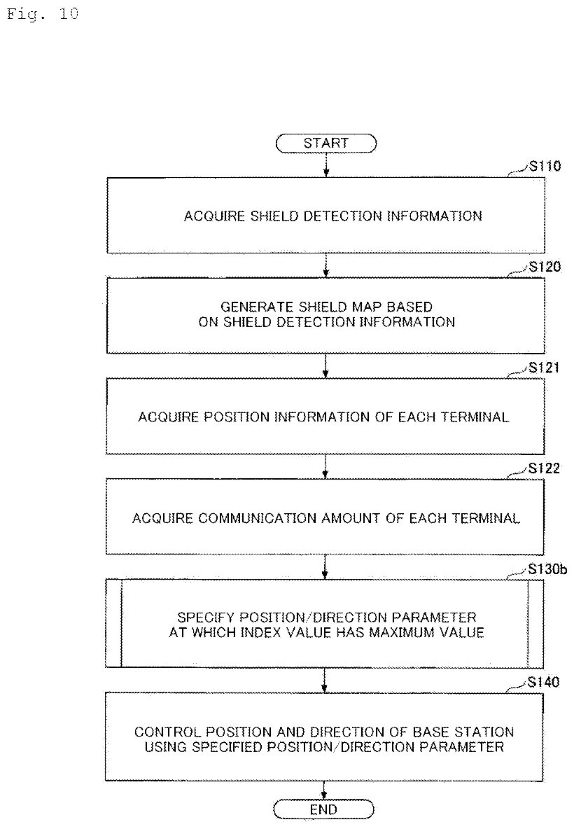

FIG. 10 is a flowchart for describing an example of a processing procedure performed by the control device 10 according to the third embodiment. In FIG. 10, the same steps as those in FIG. 9 are assigned the same step numbers, and description thereof will be omitted. In FIG. 10, step S130 is changed to step S130b, and step S122 is added between step S121 and step S130b.

In step S122, the parameter specifying unit 12 acquires the communication amount of each terminal 40. The communication amount of a certain terminal 40 may be uploaded from each terminal 40 or acquired from each base station 21. Furthermore, the communication amount of each terminal 40 may be acquired together with terminal position information. Further, since the position of each terminal 40 can be specified based on the terminal position information at the time point of step S122, the terminal 40 whose communication amount is to be acquired may be limited to visibility terminals.

In step S130b, the parameter specifying unit 12 calculates, for each combination of values that can be taken for a position/direction parameter of each base station 21, an index value of the communication area (the sum of communication amounts of visibility terminals) based on a shield map, each piece of terminal position information, and the communication amount of each terminal 40, and specifies the combination in which the index value has a maximum value.

More specifically, in step S307 of FIG. 8, the parameter specifying unit 12 specifies visibility terminals for the parameter value k1 and the parameter value k2, and calculates the sum of communication amounts of the visibility terminal. The parameter specifying unit 12 stores the calculation result in the memory device 103, the auxiliary storage device 102, or the like in association with a set of the parameter value k1 and the parameter value k2. Thus, in the third embodiment, information in which the column of “index value” in FIG. T2 is changed to “the sum of communication amount of visibility terminals” is calculated in step S307.

In step S308 of FIG. 8, the parameter specifying unit 12 specifies a set of the parameter value k1 and the parameter value k2 corresponding to the maximum value among the sum of throughputs of the visibility terminals calculated in step S307.

As described above, according to the third embodiment, for a position and a direction of each base station 21, values that maximize the sum of communication amounts of the visibility terminals that changes in accordance with a position, a shape, and the like of the shield 50 can be specified. Therefore, a communication area can be formed according to the shield 50.

In addition, according to the third embodiment, the off-loading effect can be maximized.

Further, the third embodiment is suitable when the presence or position of the terminals 40 can be managed or detected such as use of a closed area of local 5G or the like, and when a backup RAT such as Sub-6 coexists.

Next, specific examples of a visibility range specifying method according to the first to third embodiments will be described.

### First Specific Example

An area through which a line segment from a point at the center position of an antenna of the base station 21 to collision with a wall of a space P1 or a shield 50 passes is defined as a visibility range.

In this case, the visibility range can be easily specified only with the shape of the space P1 and the position and shape of the shield 50 position regardless of the position of the terminal 40.

### Second Specific Example

A Fresnel zone is calculated for each point on a predetermined grid from the point of the center position of the antenna of the base station 21, and a point of the Fresnel zone where a predetermined x % is not shielded is defined as a visibility position, and the area around the grid is defined as a visibility range.

In this case, the visibility range can be specified only with the shape of the space P1 and the position and shape of the shield 50 position regardless of the position of the terminal 40.

Next, a specific example of a visibility terminal specifying method according to the second or third embodiment will be described.

A Fresnel zone is calculated for each terminal 40 from the point of the center position of the antenna of the base station 21, and a terminal 40 in the Fresnel zone in which a predetermined x % is not shielded is defined as a visibility terminal.

In this case, in a case in which the position of the terminal 40 is static to some extent, a visibility terminal can be specified only with the shape of the space P1 and the position and shape of the shield 50 position.

Further, the Fresnel zone can be calculated by using the following formula.

$$d3 = \sqrt{d {1}^{2} + r {1}^{2}} + \sqrt{d {2}^{2} + r {1}^{2}} - d = \frac{λ}{2} \qquad [ Math . 1 ]$$

$$r 1 ( m ) = \sqrt{λ \frac{d 1 d 2}{d 1 + d 2}} = \frac{\sqrt{λ d}}{2}$$

Each of the parameters has a meaning as follows.
d: Shortest distance between the transmission and reception sides (m)
r1: Radius of the central part of a spheroid (Fresnel radius) (m)
d1: Distance from the transmission side to the center of the spheroid (m):
d2: Distance from the reception side to the center of the spheroid (m)
d3: Difference in path between a reflected wave reflected on a Fresnel radius portion and a direct wave (m)
λ: Wavelength (m)

Further, in each of the above-described embodiments, the shield map generation unit 11 is an example of a generation unit. The parameter specifying unit 12 is an example of a calculation unit.

Although embodiments of the present invention have been described in detail above, the present invention is not limited to the specific embodiments described above, and various modifications and changes can be made within the scope of the gist of the present invention described in the claims.

### REFERENCE SIGNS LIST

10 Control device
11 Shield map generation unit
12 Parameter specifying unit
13 Control unit
20 Mobile base station
21 Base station
22 Mobile structure
30 Shield detector
40 Terminal
50 Shield
100 Drive device
101 Recording medium
102 Auxiliary storage device
103 Memory device
104 CPU
105 Interface device
B Bus

1. A control system comprising:
a plurality of base stations capable of changing a transmission point of radio waves in a space; and
a control device,
wherein the control device includes
a memory; and
a processor configured to:
generate a shield map indicating a position and a shape of a shield against the radio waves in the space,
calculate, for each combination of values of one or more parameters for determining the transmission point, an index value related to a range in which radio waves of one or more of the base stations are not shielded by the shield based on the transmission point of each of the plurality of base stations in the combination and the shield map, and
control change of the transmission point of each of the plurality of base stations based on the combination in which the index value has a maximum value.

2. The control system according to claim 1, wherein the index value indicates a size of the range.

3. The control system according to claim 1, wherein the processor acquires position information of each of one or more terminals in the space, and calculates, as the index value, the number of the terminals included in a range in which radio waves of one or more of the base stations are not shielded by the shield based on the shield map and the position information of each of the terminals.

4. The control system according to claim 1, wherein the processor acquires position information and a communication amount of each of one or more terminals in the space, and calculates, as the index value, the sum of communication amounts of the terminals included in a range in which radio waves of one or more of the base stations are not shielded by the shield based on the shield map and the position information and communication amount of each of the terminals.

5. A control device configured to control change of a transmission point of a plurality of base stations capable of changing the transmission point of radio waves in a space, the control device comprising:
a memory; and
a processor configured to:
generate a shield map indicating a position and a shape of a shield against the radio waves in the space;
calculate, for each combination of values of one or more parameters for determining the transmission point, an index value related to a range in which radio waves of one or more of the base stations are not shielded by the shield based on the transmission point of each of the plurality of base stations in the combination and the shield map; and
control change of the transmission point of each of the plurality of base stations based on the combination in which the index value has a maximum value.

6. A control method executed by a control device including a memory and a processor in a control system including a plurality of base stations capable of changing a transmission point of radio waves in a space, and the control device, the control method comprising:
generating a shield map indicating a position and a shape of a shield against the radio waves in the space,
calculating, for each combination of values of one or more parameters for determining the transmission point, an index value related to a range in which radio waves of one or more of the base stations are not shielded by the shield based on the transmission point of each of the plurality of base stations in the combination and the shield map, and
controlling change of the transmission point of each of the plurality of base stations based on the combination in which the index value has a maximum value.

7. A non-transitory computer-readable recording medium having computer-readable instructions stored thereon, which, when executed, cause a computer including a memory and a processor to function as the control device according to claim 5.
